(19) United States
(12) Patent Application Publication
(10) Pub. No.: US 2013/0127821 A1
(43) Pub. Date: May 23, 2013

(54) METHOD AND SYSTEM FOR ADJUSTING A DISPLAY TO ACCOUNT FOR THE USERS' CORRECTIVE LENSES OR PREFERRED DISPLAY SETTINGS

(71) Applicants: Jeffrey Phillip Lewis, London (CA); Alex Weiner, London (CA)

(72) Inventors: Jeffrey Phillip Lewis, London (CA); Alex Weiner, London (CA)

(21) Appl. No.: 13/468,664

(22) Filed: May 10, 2012

Related U.S. Application Data
(60) Provisional application No. 61/484,758, filed on May 11, 2011.

(51) Int. Cl. G06T 11/00

(52) U.S. Cl. CPC G06T 11/00
USPC 345/418

(57) ABSTRACT

A system and method for adjusting display settings to allow a user that requires prescriptive eyewear to view images on the display without the eyewear. The user provides input on which value for each display setting is optimal for the user's viewing experience. Once the optimal values are determined, the present invention adjusts the settings of the display means. The user is then able to view the text or images without wearing his/her prescriptive eyewear. The present invention optimally manipulates at least one of the following settings to achieve this aim: brightness, contrast, clock/phase, sharpness, colour, resolution, aspect ratio, gamma setting, and any other settings of the display means that are available to adjust the display so that a user may view the image to his or her satisfaction. The display means may be a monitor, or any other means that displays text or images.

### RELATED APPLICATIONS

This application claims priority on U.S. Patent Application Ser. No. 61/484,758 filed May 11, 2011, which is incorporated herein by reference.

### FIELD OF INVENTION

The present invention relates to methods and systems for vision testing and correcting.

### BACKGROUND OF THE INVENTION

We live in a world where people are constantly looking at electronic displays. Whether people have handheld devices, such as a mobile phone or a tablet computing device, or work in front of a laptop or a desktop computer, many people spend a significant amount of their day looking at these electronic displays. For the visually impaired, i.e., those in need of corrective eyewear, this can be a fatiguing endeavour.

Many with corrective eyewear, such as prescription eyeglasses, would like to take off their glasses to view the display. Yet, they are unable to remove them and still clearly see the image. In fact, it is not uncommon to see eyeglass wearers squint their eyes to view the display on their mobile device. To date, there are no systems or methods to enable a visually impaired person to easily view the display without corrective eyewear.

Even those that do not wear corrective eyewear may have trouble viewing these electronic displays. As such, there is a need to be able to adjust the display settings to optimize the viewing experience for the user.

### SUMMARY OF THE INVENTION

The present invention seeks to provide a system and method for adjusting display settings to allow a user who requires prescriptive eyewear to view images on a display means without the eyewear. According to the present invention, the user provides their current corrective lens prescription and/or input on which value for each display setting is optimal for the user's viewing experience. Once the optimal values are determined, the present invention adjusts the settings of the display means. The user is then able to view the text or images without wearing his/her prescriptive eyewear. The present invention optimally manipulates at least one of the following settings to achieve this aim: brightness, contrast, frequency and/or phase of the clock signal, sharpness, colour, resolution, aspect ratio, gamma setting, anti-aliasing and any other settings of the display means that are available to adjust the display so that a user may view the image to his or her satisfaction.

In a first aspect, the present invention provides a method of adjusting at least one value for at least one display setting of a display means to optimize a user's viewing of the display means for a computing means, the method comprising: (a) generating the at least one display setting to be adjusted; (b) generating the at least one value that corresponds to the at least one display setting; (c) determining which of the at least one value is optimal for the user's viewing of the display means; (d) updating the computing means with the optimal at least one value for the corresponding at least one display setting, and storing the optimal at least one value in data storage; and (e) repeating steps (a) through (d) for each of the at least one display setting to be adjusted.

In a second aspect, the present invention provides a system for adjusting at least one value for at least one display setting of a display means to optimize a user's viewing of the display means for a computing means, the system comprising: the computing means having a processor, data storage, and a display subsystem, and wherein the processor is operatively coupled to the data storage and the display subsystem, and wherein the display subsystem and the data storage are operatively coupled together; a display means, operatively coupled to the computing means, having at least one display setting for adjusting to at least one optimal value based on the user's input; the display subsystem for generating at least one display setting and at least one corresponding value for adjusting the at least one display setting to the at least one optimal value; and the processor processes each of the corresponding and optimal values and stores the at least one optimal value in data storage.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to an embodiment of the present invention; and

FIG. 2 is a flow chart of a method according to an embodiment of the present invention.

### DETAILED DESCRIPTION OF THE INVENTION

It should be mentioned that what is referred to as a display means in this document may be any electronic display that displays text or graphics.

It should also be mentioned here that the term data storage is a broad term that includes any type of data storage suitable for storing data for a computing means.

It should be further mentioned that the present invention is not limited to users that use corrective or prescription eyewear with corrective lenses. The present invention may also be suitable for users who do not wear corrective eyewear, and yet want to adjust the display settings of a display means to improve their viewing experience.

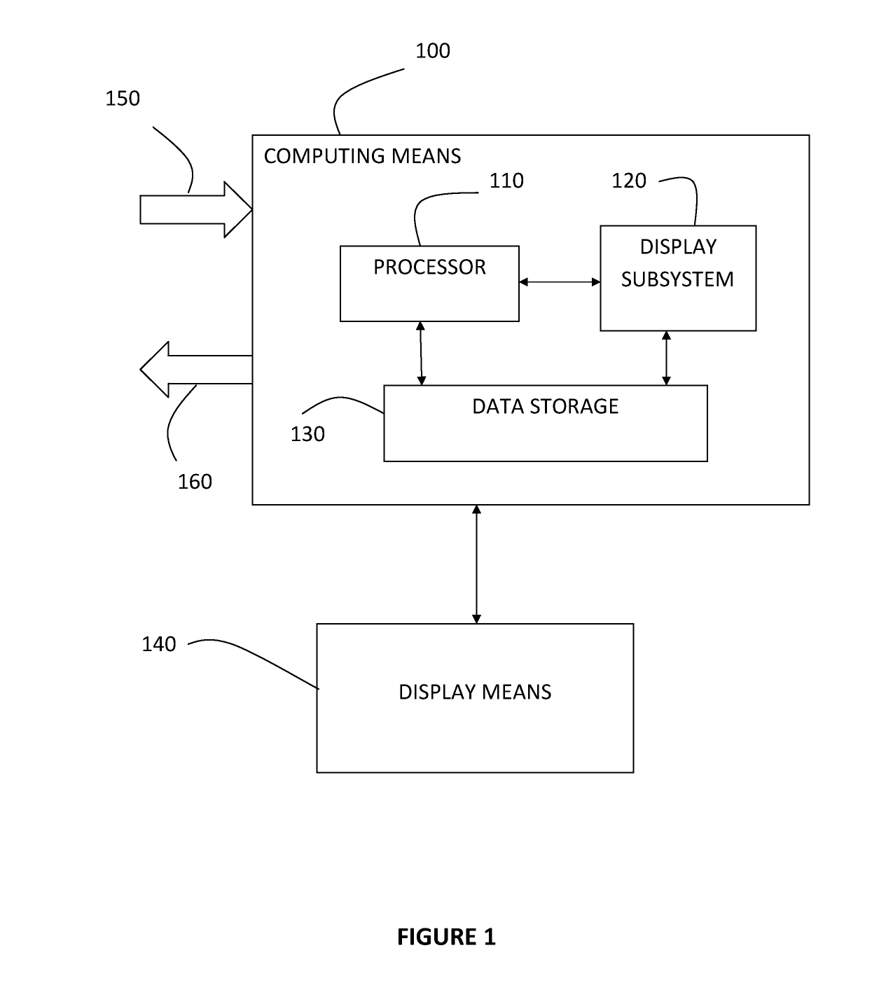

FIG. 1 is a block diagram of a system according to an embodiment of the present invention. The system includes a computing means 100 that has a processor 110, a display subsystem 120, and the storage means 130. The processor 110 is operatively coupled to the display subsystem 120 and the storage means 130. The storage means 130 is also operatively coupled to the display subsystem 120. The computing means 100 is also operatively coupled to a display means 140. The computing means has an input 150 and an output 160 for communication with the user.

According to the present invention, the computing means may be any computer, such as, but not limited to, a desktop, a laptop, a handheld computing device, a tablet, a cellular phone, smart phone or the like.

Further in accordance with the present invention, the display means may be a text or a graphical display means, such as, but not limited to, a liquid crystal display (LCD), a plasma display, or a light emitting diode (LED) display, or the like.

It should also be mentioned that the display subsystem is another broad term. The display subsystem may be embodied in a video card within a computer, for example.

According to the present invention, the system 100 determines which display settings and corresponding values must be adjusted to enable the user to optimally view the text or graphic on the display means. The display subsystem 120 generates display settings and corresponding values that need to be adjusted. Then, the display means 140 will present the user with a display setting at a particular value. The user will then use the input 150 to provide feedback as to whether the particular value is optimal for the user's viewing.

At least one display setting can be adjusted according to the present invention. The display subsystem 120 will cycle through each display setting that may need to be adjusted for the user. As the user inputs each optimal value for a particular setting, the processor 110 processes these values and stores the optimal values in storage 130. As optimal values are being stored, the display subsystem 120 will update the display means 140 with the optimal value for each display setting. The display means 140 will then adjust the display setting accordingly.

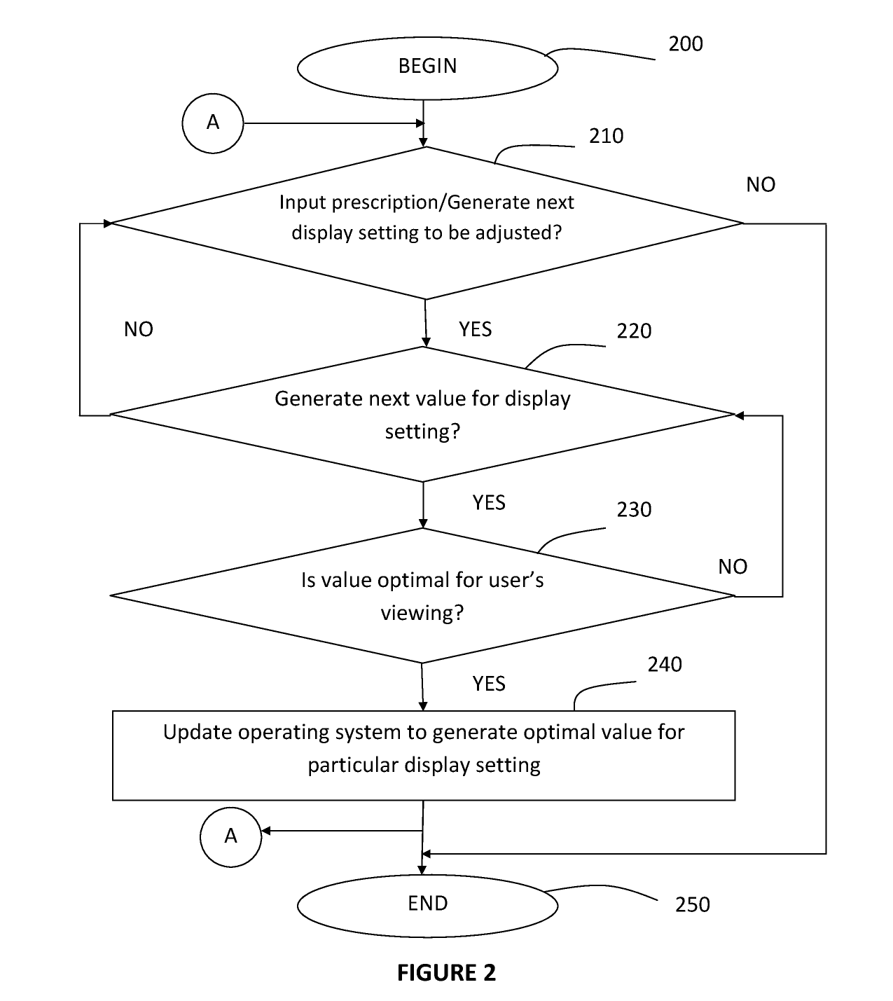

FIG. 2 is a flow chart of a method according to an embodiment of the present invention. The method begins at step 200. In step 210, the method determines whether a next display setting should be adjusted and enables the user to input their prescription details. If there is no further display setting to be adjusted, the method moves to step 250 where it ends. If there is a next display setting to be generated, the display setting is generated and the method follows to the next step.

At step 220, the method determines whether there is a next value for that particular setting that can be selected and presented as a viewing characteristic to the user. If there is no next value, the method returns to step 210. If there is a next value, the value is generated at step 220 and the method follows to the next step.

At step 230, the method determines whether that next value for the particular display setting is optimal for the user's viewing of the display means. Here, the user will provide input on whether the viewing characteristic of the value renders the text or image more optimal for viewing by the user. If the value is not optimal, the method returns to step 220. If the value is optimal, the method proceeds to the next step 240.

At step 240, the method uses the operating system of the computing system to generate the optimal value for the particular display setting. The method also stores the optimal value in storage. Following that, the process will follow connector A back to step 210. If there is a further display setting to be adjusted the method will proceed to generate that display setting. Otherwise, the method will proceed to step 250 where it ends.

Depending on the type of computing system, a variety of display settings may be adjusted. The following are display settings that may be adjusted, but the present invention is in no way limited to the following as others may be readily apparent to the skilled artisan:
Screen Resolution;
Screen Brightness;
Screen Contrast;
Colour;
Aspect ratio;
Gamma setting;
Refresh Rate;
Font Size;
Font Type;
Video Clock Frequency;
Video Clock Phase;
Font Weight;
Anti-aliasing;
Window Positioning; and
Window Sizing.

It should also be mentioned that the display settings are adjusted for a particular focal length between the user's eyes and the display means. In other words, the display settings will optimize the user's viewing of the display means for the user's distance from the display means. Should the user move closer to or further away from to the display means, the method of the present invention may need to be initiated again by the user.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g.“C”) or an object oriented language (e.g.“C++”). Alternative embodiments of the invention may be implemented as pre-programmed hardware elements, other related components, or as a combination of hardware and software components. Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

Having thus described the invention, what is claimed as new and secured by Letters Patent is:

1. A method of adjusting at least one value for at least one display setting of a display means to optimize a user's viewing of the display means for a computing means, the method comprising:
a) generating the at least one display setting to be adjusted;
b) generating the at least one value that corresponds to the at least one display setting;
c) determining which of the at least one value is optimal for the user's viewing of the display means;
d) updating the computing means with the optimal at least one value for the corresponding at least one display setting, and storing the optimal at least one value in data storage; and
e) repeating steps (a) through (d) for each of the at least one display setting to be adjusted.

2. A method as in claim 1, wherein the at least one display setting is selected from the group consisting of: screen resolution; screen brightness; screen contrast; colour; aspect ratio; gamma setting; refresh rate; clock frequency; clock phase; font size; font type; font weight; anti-aliasing; window positioning; and window sizing.

3. A method as in claim 1, wherein the step of enabling the user to input their prescription details is provided.

4. A system for adjusting at least one value for at least one display setting of a display means to optimize a user's viewing of the display means for a computing means, the system comprising:
the computing means having a processor, data storage, and a display subsystem, and wherein the processor is operatively coupled to the data storage and the display subsystem, and wherein the display subsystem and the data storage are operatively coupled together;
a display means, operatively coupled to the computing means, having at least one display setting for adjusting to at least one optimal value based on the user's input;
the display subsystem for generating at least one display setting and at least one corresponding value for adjusting the at least one display setting to the at least one optimal value; and
the processor processes each of the corresponding and optimal values and stores the at least one optimal value in data storage.

5. A system as in claim 4, wherein the at least one display setting is selected from the group consisting of: screen resolution; screen brightness; screen contrast; colour; aspect ratio; gamma setting; refresh rate; clock frequency; clock phase; font size; font type; font weight; anti-aliasing; window positioning; and window sizing.

6. A system as in claim 4, wherein the display means displays text and graphic to the user.

7. A system as in claim 4, wherein the computing means is selected from the group consisting of: a laptop computer, a desktop computer, a tablet computing device, a handheld computing device, and a mobile computing device.

8. A system as in claim 4, wherein the display means is selected from the group consisting of: a liquid crystal display (LCD), a plasma display, and a light emitting diode (LED) display.
